(19) United States
(12) Patent Application Publication
(10) Pub. No.: US 2018/0233008 A1
(43) Pub. Date: Aug. 16, 2018

(54) A METHOD GUARDING AN OBJECT OR AREA, A GUARDING UNIT AND A COMPUTER PROGRAM PRODUCT

(71) Applicant: Van Ginderen License and Finance B.V., 's-Gravenhage (NL)

(72) Inventor: Emile Willem Hoos, Den Haag (NL)

(21) Appl. No.: 15/511,876

(22) PCT Filed: Sep. 17, 2015
(86) PCT No.: PCT/NL2015/050643

§ 371 Date: Mar. 16, 2017

(30) Foreign Application Priority Data
Sep. 17, 2014 (NL) 2013480

(51) Int. Cl. G08B 13/196

(52) U.S. Cl. CPC G08B 13/1965; G08B 13/19652

(57) ABSTRACT

The invention relates to a method of guarding an object or area. The method comprises the steps of scanning an area surrounding the object or area to be guarded using a scanning signal, localizing a moving object detected by the scanning signal, and generating a warning signal only if the detected moving object is localized in a safety zone that is enclosed by a pre-defined contour.

The invention relates to a method of guarding an object or area such as an airplane or a car.

Hangars usually accommodate a multiple number of airplanes so that indoor parking room is used efficiently. Also, maintenance equipment can be exploited in an efficient manner. Since airplanes are expensive and may be subject to sabotage security measures may be applied e.g. depending on the value of the airplanes.

Air planes can be guarded with dedicated guarding devices including laser scanning devices and/or cameras. However, such guarding devices typically guard a wide area around the airplane e.g. a disc shaped area or a semi-disc area so that a substantial floor area can effectively not used for other activities such as maintenance processes and/or flight preparing activities applied on other, neighbouring airplanes.

It is an object of the invention to provide a method of guarding an object or area, wherein parking area can be exploited more efficiently. Thereto, according to an aspect of the invention, a method is provided, comprising the steps of scanning an area surrounding the object or area to be guarded using a scanning signal, localizing a moving object detected by the scanning signal, and generating a warning signal only if the detected moving object is localized in a safety zone that is enclosed by a pre-defined contour.

By pre-defining a contour enclosing a safety zone guarding activities can be focused on an area that is of interest for the object or area to be guarded, e.g. an area that is occupied by the object or area to be guarded itself with an additional safety band around said occupied area. By localizing a detected moving object discrimination can be made between highly relevant moving objects, and objects that are less relevant or not relevant at all. If the localized moving object is within the safety zone, it is determined that it is relevant for the object or area to be guarded, and a warning signal is generated. Otherwise, the warning signal is not generated.

Since activities in the scanned area outside the safety zone are determined to be of less relevance, the guarding function is now associated with the real area of interest. Activities outside said safety zone may take place without disturbing the guarding process. Then, airplanes can be parked more close to each other thereby more efficiently exploiting the parking area.

By pre-defining the contour enclosing the safety zone, the guarding process can dynamically and flexibly be focused on the real area of interest for securing the object or are to be guarded.

It is noted that patent publication WO 2006/027762 discloses a collision avoidance warning system for an aircraft, comprising a light source, sensors and processing means for determining the dimensions and location of an object relative to the aircraft.

It is further noted that patent publication U.S. Pat. No. 6,188,319 discloses an intruder detection system for detecting the presence of an intruder in a protected area.

It is also noted that patent publication EP 0 532 976 discloses a system for guarding buildings, vehicles and persons using a laser beam.

In an advantageous manner the contour is defined by tracking a person moving around the object or area to be guarded. Thus, by walking around the object or area to be guarded the safety zone is set. In this way, a user-specific safety zone can easily be defined, preferably by using the same equipment that scans the scanning area so that no additional devices are needed.

The invention also relates to a guarding unit.

Further, the invention relates to a computer program product. A computer program product may comprise a set of computer executable instructions stored on a data carrier, such as a flash memory, a CD or a DVD. The set of computer executable instructions, which allow a programmable computer to carry out the method as defined above, may also be available for downloading from a remote server, for example via the Internet, e.g. as an app.

Other advantageous embodiments according to the invention are described in the following claims.

By way of example only, embodiments of the present invention will now be described with reference to the accompanying figures in which

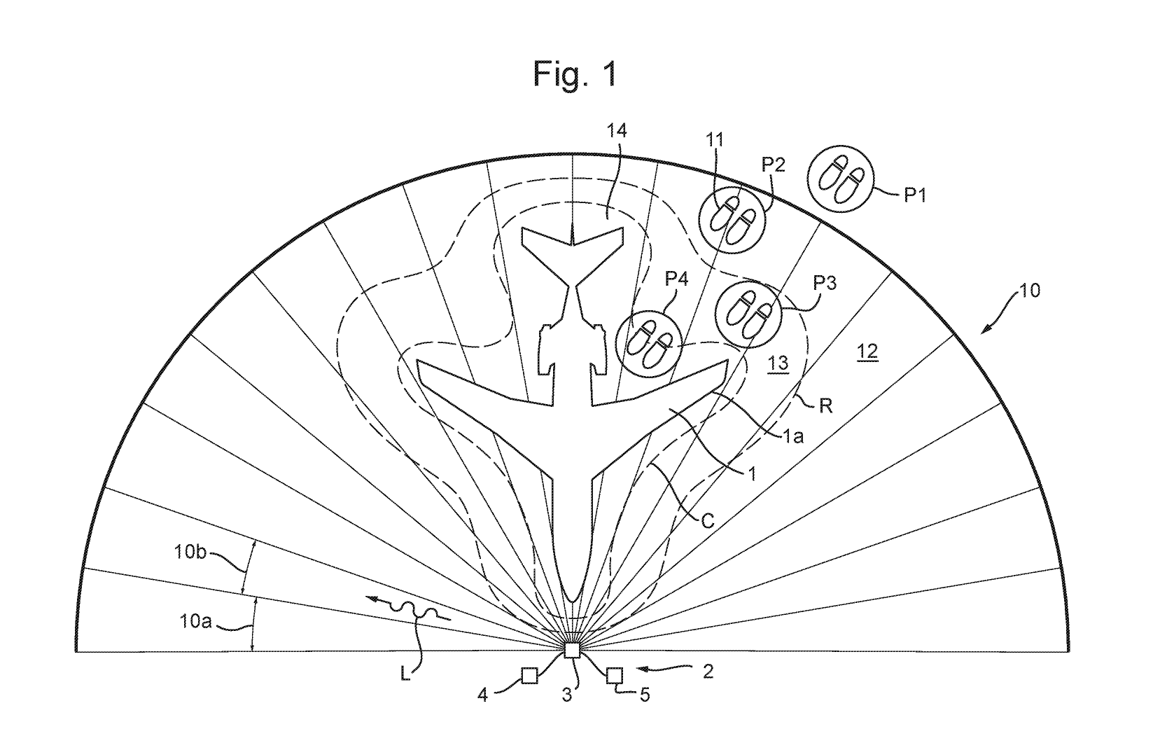

FIG. 1 shows a schematic top view of an object to be guarded by a guarding unit according to a first embodiment of the invention;

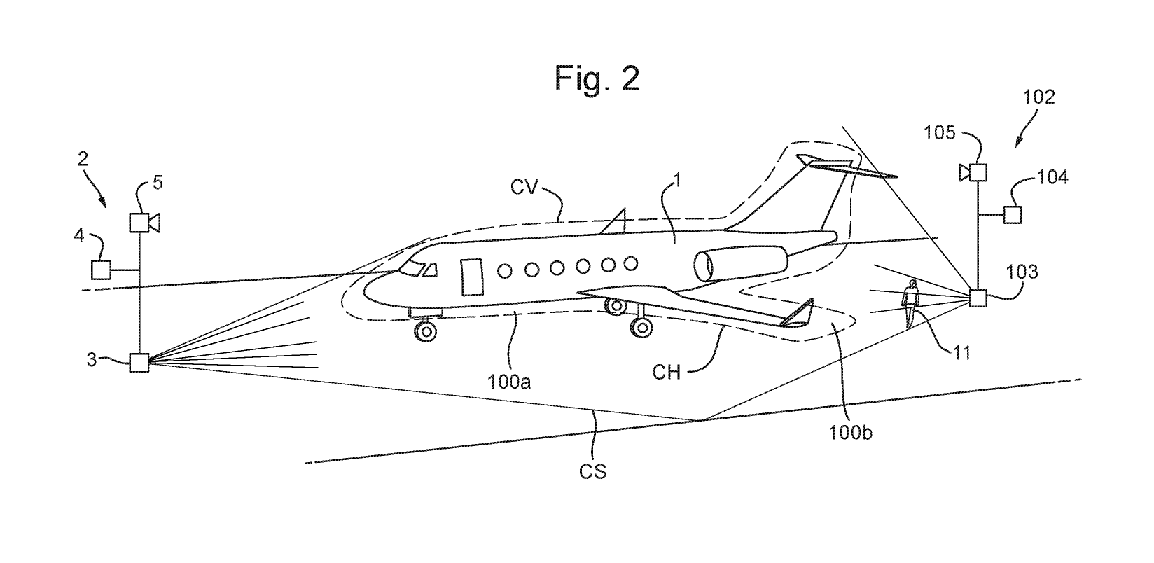

FIG. 2 shows a schematic perspective view of an object to be guarded by a guarding unit according to a second embodiment of the invention;

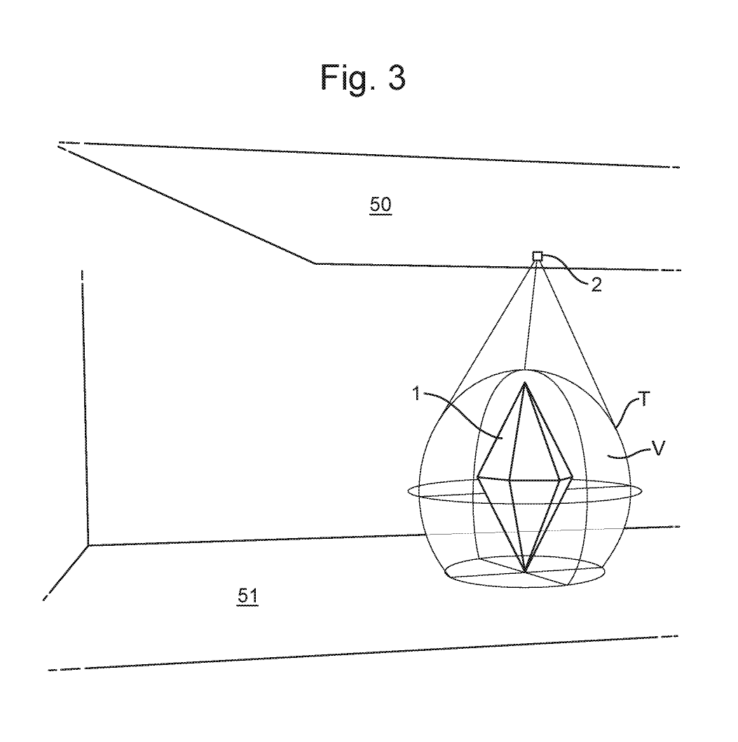

FIG. 3 shows a schematic perspective view of an object to be guarded by a guarding unit according to a third embodiment of the invention, and

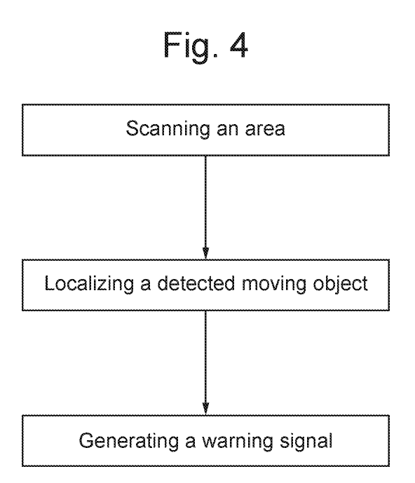

FIG. 4 shows a flow chart of an embodiment of a method according to the invention.

The figures merely illustrate preferred embodiments according to the invention. In the figures, the same reference numbers refer to equal or corresponding parts.

FIG. 1 shows a schematic top view of an object 1 to be guarded by a guarding unit 2 according to a first embodiment of the invention. The object 1 to be guarded is an airplane parked in a hangar.

The guarding unit 2 comprises a scanning device 3 for scanning an area 10 surrounding the object 1 to be guarded. In the embodiment shown in FIG. 1 the scanning device 3 includes a single laser unit generating a narrow band scanning signal implemented as a laser beam L scanning a two-dimensional area 10 over a range of circa 180°. The scanned area 10 thus has the shape of a semi disc. It is noted that, alternatively, the laser unit can be implemented or programmed to scan over another range, e.g. a range of circa 360° or a range of circa 90°. The scanning device 3 is positioned in front of the airplane 1. In principle, however, the scanning device 3 can be placed at other locations, e.g. near a wing tip or behind the tail, outside a safety zone. The scanning device 3 is preferably located remote from the object to be guarded. Preferably, the pre-defined contour surrounds the object or area to be guarded. Preferably, the scanning device 3 is positioned such that the entire airplane to be scanned is within the scanned area 10 to counteract that an area adjacent to the airplane 1 is not guarded.

During operation of the guarding unit 2 the above mentioned area 10 surrounding the airplane 1 is scanned using the laser beam L. Then, the scanning device 3 transmits the laser beam L in consecutive angular directions corresponding with sectors 10a,b in the scanned area 10. The scanning device 3 also receives reflections from objects that are present in said scanned area 10.

The guarding unit 2 comprises a controller 4 for localizing a moving object detected by the scanning device 3. By keeping track of the orientation of the transmitted laser beam L and a time lapse between transmission of a scanning signal and receipt of a reflection signal the position of the object can be determined. For the purpose of localizing moving objects, the scanned area 10 can be subdivided into sectors 10a,b and regions in each sector called cells. Moving objects can be discriminated from static objects by storing location information of detected objects and by tracking positions of detected objects over time.

The scanned area 10 is virtually divided into three zones, viz. a free zone 12, a pre-safety zone 13 and a safety zone 14 to be set by a user of the guarding unit 2. The safety zone 14 is the area within a closed pre-defined contour C also called periphery. Usually, the contour C surrounds the airplane 1 so that a safety zone 14 around the airplane 1 is defined. In the embodiment shown in FIG. 1 the contour C is two-dimensional forming a closed loop. The pre-safety zone 13 is a loop area around the safety zone 14, the pre-safety zone 13 being bounded at a radial inner side by the pre-defined contour C and at a radial outer side by a pre-safety contour R. In practice, the pre-safety zone 13 can be implemented as a strip area having an optionally pre-set width, e.g. circa 1 meter or circa several meters, from the pre-defined contour C. The free zone 12 is the scanned area 10 outside the safety zone 14 and the pre-safety zone 13.

The pre-defined contour C is preferably user-specified is explained below. Then, the contour C is defined by tracking a person moving around the airplane 1. Preferably, the moving person is tracked using the scanning signal of the scanning device 3 so that no additional tracking devices are needed. Alternatively, the moving person is tracked using another device such as a camera. If the moving person is in a blind spot of the scanning device 3, the tracked positions may have interruptions. In order to close the contour the interruptions can advantageously be replaced by interpolation segments connecting a traced end position before the interruption starts, to a traced start position after the interruption ends. The interpolation process can be performed using dedicated software and/or using a user interface.

As an alternative to applying a user-specified pre-defined contour C, the pre-defined contour C may be pre-programmed using available geometry information of the airplane 1, such as shape and dimensions. Then, the contour C may be defined as a loop that is an optionally pre-set distance from the outer contour 1a of the airplane 1.

In principle, the pre-defined contour C can be determined by performing the step of localizing the object or area to be guarded using the scanning device 3, and the step of setting a contour C around the localized object or area. The guarding unit 2 can be provided with means for setting the contour C, e.g. a display for displaying the localized object or area and a user-interface including hardware and/or software components so that a user may select a localized object or area, and indicate the contour C. As an alternative, the step of localizing the object or area to be guarded can be performed using image data recorded by at least one camera.

The guarding unit 2 may be operated in at least two states, viz. an initialization state wherein the contour C is defined, and a monitoring state wherein the airplane is guarded for surveillance purposes.

In principle, a detected moving object 11 is located in either a position P2 in the free zone 12, or a position P3 in the pre-safety zone 13 or a position P4 in the safety zone 14 of the scanned area 10. If a moving object is at a location P1 outside the scanned area zone 10, it is not detected by the guarding unit 2.

The controller 4 of the guarding unit 2 is arranged for generating a warning signal only if the detected moving object is localized in the safety zone 14 that is enclosed by a pre-defined contour C. Further, in a preferred embodiment, the warning is only generated when it is detected that the detected object is moving or has moved during a period of time.

The guarding unit 2 also comprises a camera 5 for recording at least one image of the location where the moving object is detected, in response to said warning signal. Preferably, a multiple number of images are recorded and stored. Further, optionally, and in response to the warning signal, an alert signal is forwarded to a monitor system such as security emergency or security room so that security personnel is activated. In addition, a recorded image or a multiple number of the recorded images can be transmitted to the monitor system so that activities around the airplane can be viewed instantly. Also other monitoring systems can be activated such as sound recording devices.

Further a sound alarm, a spoken text and/or light signals can be generated to deter an intruder.

The controller 4 of the guarding unit 2 can further be arranged for generating a pre-warning signal if the detected moving object is localized in the pre-safety zone 13. In response to the pre-warning signal, also images can be recorded and stored. Generally, a lower warning level is initiated compared with the situation wherein a moving object is detected in the safety zone 14.

In order to minimize blind spots in the scanning zone 10, the scanning device is preferably positioned and oriented such that the scanning signal propagates at a level between the fuselage and the landing wheels of the airplane 1. Alternatively, the scanning signal propagates at another level, e.g. a few decimeters above ground level.

FIG. 2 shows a schematic perspective view of an object to be guarded by a guarding unit 2, 102 according to a second embodiment of the invention. Again, the object is an airplane 1. The guarding unit 2, 102 includes a scanning device that comprises a multiple number of laser units, viz. a first laser unit 3 positioned in front of the airplane 1 and a second laser unit 103 positioned behind the back of the airplane 1.

Both the first laser unit 3 and the second laser unit 103 generate a scanning signal. However, the scanning signals are three dimensional meaning that they each scan a three dimensional cone volume CS. The combined three dimensional cone volumes form a dome-shaped volume surrounding the airplane 1.

Analogous to the embodiment shown in FIG. 1, the guarding unit 2, 102 further comprises a first controller 4 and a second controller 104 that are each arranged for localizing a moving object detected by the corresponding scanning signal, and for generating a warning signal if the detected moving object 11 is localized in a safety zone 100a, 100b that is enclosed by a pre-defined contour. Here, the contour is a closed three-dimensional surface enclosing the airplane 1. A vertical projection of the contour is shown in FIG. 2 as a vertical projection contour CH similar to the two-dimensional contour C in FIG. 1. Further, a horizontal projection of the contour is shown in FIG. 2 as a horizontal projection contour CV. In principle, the first controller 4 and the second controller 104 can be integrated in a single controller.

In other embodiments, even more than two laser units are used for scanning the area wherein the airplane is placed.

In the above described embodiments, hardware components such as the laser unit, the controller and the camera mutually exchange signals such as control signals and data signals. Said signals are transmitted via wired or wireless signal channels such as short range or telecommunication wireless communication channels, or radio communication lines.

FIG. 3 shows a schematic perspective view of an object 1 to be guarded by a guarding unit 2 according to a third embodiment of the invention. Here, the guarding unit 2 is mounted on the ceiling 50 above a floor 51 supporting the object to be guarded, here a diamond 1. The scanning device of the guarding unit 2 is arranged for scanning a three-dimensional space. Again a dome-shaped volume V is defined surrounding the object to be guarded. The dome-shaped volume V forms the a safety zone that is enclosed by a pre-defined three-dimensional contour T.

FIG. 4 shows a flow chart of an embodiment of a method according to the invention. The method is used for guarding an object or area. The method comprises a step of scanning 110 an area surrounding the object or area to be guarded using a scanning signal, a step of localizing 120 a moving object detected by the scanning signal, and a step of generating 130 a warning signal only if the detected moving object is localized in a safety zone that is enclosed by a pre-defined contour.

The method of guarding an object or area can be facilitated using dedicated hardware structures, such as FPGA and/or ASIC components. Otherwise, the method can also at least partially be performed using a computer program product comprising instructions for causing a processor of a computer system or a control unit to facilitate localizing a moving object detected by the scanning signal. All (sub)steps can in principle be performed on a single processor. However, it is noted that at least one step can be performed on a separate processor. A processor can be loaded with a specific software module. Dedicated software modules can be provided, e.g. from the Internet.

Although the guarding unit is described referring to an airplane to be guarded, also other objects or areas can be guarded, such as a car, a boat, a festival platform, a catwalk, a precious object in a museum, a sport area, a swimming pool, a private entrance area etc. It is noted that an area to be guarded can be either a surface such as a floor, or a volume such as a dome-shaped volume adjacent or above a floor.

The invention is not restricted to the embodiments described herein. It will be understood that many variants are possible.

As an example, the scanning device can be provided with a radar equipment or a passive IR system for scanning the area surrounding the object or area to be guarded, as an alternative to a laser unit.

As another example, the scanning device is located below the airplane or is even integrated therewith, then preferably scanning over a range of 360°.

Further, the pre-safety zone can be omitted. Then, the scanned area can virtually be split up into a safety zone as described above and a free zone being the remaining area in the scanned area, so that a simplified monitor structure is obtained wherein either a warning signal is generated or no warning or pre-warning signal is generated.

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

1. A method of guarding an object or area, comprising:
scanning an area surrounding the object or area to be guarded using a scanning signal;
localizing a moving object detected by the scanning signal, and
generating a warning signal only if the detected moving object is localized in a safety zone that is enclosed by a pre-defined contour.

2. A method according to claim 1, wherein the scanning signal is a narrow-band signal.

3. A method according to claim 1, wherein the pre-defined contour is user-specified.

4. A method according to claim 1, wherein the contour is defined by tracking a person moving around the object or area to be guarded.

5. A method according to claim 4, wherein the moving person is tracked using the scanning signal.

6. A method according to claim 5, wherein the contour is closed by interpolating interruptions in tracked positions of the moving person.

7. A method according to claim 1, wherein the contour is pre-programmed using available geometry information of the object or area to be guarded.

8. A method according to claim 1, wherein the scanning signal scans a two-dimensional area over a range of about 180°.

9. A method according to claim 1, wherein the scanning signal propagates at a level between the fuselage and the landing wheels of an airplane to be guarded.

10. A method according to claim 1, wherein a volume surrounding the object or area to be guarded is scanned using a multiple number of scanning signals.

11. A method according to claim 1, further comprising a step of generating a pre-warning signal if the detected moving object is localized in a security zone being a loop area around the safety zone.

12. A method according to claim 1, further including a step of recording at least one image of the location wherein the moving object is detected, in response to the warning signal and/or pre-warning signal.

13. A method according to claim 1, wherein the pre-defined contour surrounds the object or area to be guarded.

14. A method according to claim 1, wherein the step of scanning the area is performed using a scanning device located outside the safety zone.

15. A guarding unit for guarding an object or area, comprising a scanning device for scanning an area surrounding the object or area to be guarded, further comprising a controller for localizing a moving object detected by the scanning device, and for generating a warning signal only if the detected moving object is localized in a safety zone that is enclosed by a pre-defined contour.

16. A guarding unit according to claim 15, wherein the scanning device includes at least one laser units.

17. A guarding unit according to claim 15, further comprising a camera for recording at least one image of the location wherein the moving object is detected, in response to the warning signal.

18. A computer program product for guarding an object or area, the computer program product comprising computer readable code for causing a processor to facilitate a process including the steps of:
scanning an area surrounding the object or area to be guarded using a scanning signal;
localizing a moving object detected by the scanning signal, and
generating a warning signal only if the detected moving object is localized in a safety zone that is enclosed by a pre-defined contour.
